(19) United States
(12) Patent Application Publication
(10) Pub. No.: US 2026/0165237 A1
(43) Pub. Date: Jun. 18, 2026

(54) WALK-BEHIND MOWER WITH OPERATOR PRESENCE CONTROL

(71) Applicant: Textron Inc., Providence, RI (US)

(72) Inventors: Luke John Peter Manning, Stowmarket (GB); Jamie Mark Clements, Ipswich (GB); Michael Mthokozisi Mpofu, Ipswich (GB); William Christopher Dickson, Stowmarket (GB)

(73) Assignee: Textron Inc., Providence, RI (US)

(21) Appl. No.: 18/979,357

(22) Filed: Dec. 12, 2024

(51) Int. Cl. A01D 34/00; A01D 34/67; A01D 34/68; A01D 34/82; A01D 101/00

(52) U.S. Cl. CPC A01D 34/006; A01D 34/67; A01D 34/828; A01D 2034/6843; A01D 2101/00

(57) ABSTRACT

A walk-behind mower includes a chassis, a tractive element coupled to the chassis, a cutting element rotatably coupled to the chassis, a cutter motor coupled to the cutting element, a handle assembly extending upward from the chassis, a bail arm coupled to the handle assembly, a power switch configured to selectively prevent operation of the walk-behind mower, a cutter control configured to provide a cutter activation signal in response to a user interaction, and a controller operatively coupled to the cutter motor and the cutter control. The controller is configured to activate the cutter motor to cause rotation of the cutting element in response to the bail arm moving toward an engaged position after receiving the cutter activation signal and prevent activation of the cutter motor in response to the bail arm moving toward the engaged position without having received the cutter activation signal.

### BACKGROUND

The present disclosure relates generally to outdoor equipment, such as mowers or golf cars. More specifically, the present disclosure relates to determining a route for a mower.

Mowers are used to maintain vegetation (e.g., grass, clover, weeds, etc.) at a desired height. Walk-behind mowers provide an operator interface positioned to permit control of the mower by an operator standing on the ground behind the mower. It may be desirable to automatically suspend operation of the mower if the operator becomes separated from the mower.

### SUMMARY

One embodiment relates to a walk-behind mower including a chassis, a tractive element coupled to the chassis, a cutting element rotatably coupled to the chassis, a cutter motor coupled to the cutting element, a handle assembly extending upward from the chassis, a bail arm coupled to the handle assembly and repositionable between an engaged position and a disengaged position, a power switch configured to selectively prevent operation of the walk-behind mower, a cutter control configured to provide a cutter activation signal in response to a user interaction, and a controller operatively coupled to the cutter motor and the cutter control. The controller is configured to activate the cutter motor to cause rotation of the cutting element in response to the bail arm moving toward the engaged position after receiving the cutter activation signal and prevent activation of the cutter motor in response to the bail arm moving toward the engaged position without having received the cutter activation signal.

Another embodiment relates to a walk-behind mower including a chassis, a tractive element coupled to the chassis, a cutting element rotatably coupled to the chassis, a motor coupled to the chassis and configured to drive at least one of the tractive element or the cutting element, a handle assembly extending upward from the chassis, the handle assembly including a handle body and a grip extending outward from the handle body, and the handle body defining an internal volume, a bail arm pivotably coupled to the handle body and extending within the internal volume of the handle body, and a bail arm sensor coupled to the bail arm and positioned within the internal volume of the handle body. The bail arm sensor is configured to provide a signal indicating a rotational position of the bail arm. The walk-behind mower further includes a controller operatively coupled to the motor and the bail arm sensor and configured to vary a speed of the motor based on the signal from the bail arm sensor.

Still another embodiment relates to a walk-behind mower including a chassis, a tractive element coupled to the chassis, a cutting element rotatably coupled to the chassis, a motor coupled to the chassis and configured to drive at least one of the tractive element or the cutting element, a handle assembly extending upward from the chassis, a bail arm pivotably coupled to the handle assembly and rotatable about an axis of rotation between an engaged position and a disengaged position, and a controller operatively coupled to the motor. The controller is configured to increase a speed of the motor in response to the bail arm moving from the disengaged position to the engaged position. An axial position of the bail arm along the axis of rotation remains constant as the bail arm moves between the engaged position and the disengaged position.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a is schematic block diagram of a site monitoring and control system including a plurality of the vehicles of FIG. 1, according to an exemplary embodiment.

FIGS. 4 and 5 are front perspective views of a handle assembly of the vehicle of FIG. 1, according to an exemplary embodiment.

FIG. 6 is a front view of the handle assembly of FIG. 4 being used by an operator.

FIGS. 7 and 8 are a top perspective views of the handle assembly of FIG. 4.

FIG. 9 is a top perspective view of the handle assembly of FIG. 4 with a handle removed, according to an exemplary embodiment.

FIGS. 10, 11, and 12 are side views of a cutting switch of the handle assembly of FIG. 4 in various positions, according to an exemplary embodiment.

FIG. 13 is a flowchart of a method of operating the vehicle of FIG. 1, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Certain regulations require at least two separate or distinct operator inputs before activation of a cutting unit on a walk-behind mower. Requiring two different operations ensures that the operator is present and intends to begin a mowing operation. Other walk-behind mowers accomplish this utilizing a slideable bail arm. The first input requires the operator to slide the bail arm laterally, then the second input requires the operator to rotate the bail arm by pulling it toward a handle. However, this sideways movement of the bail arm can be cumbersome, especially when repeated many times over the course of a workday. Additionally, if the operator mistakenly believes that they have completed the sideways movement of the bail arm and pulls the bail arm toward the handle, the bail arm may be bent or otherwise damaged.

Referring generally to the figures, a walk-behind mower includes features that confirm the presence of an operator without requiring sideways movement of a bail arm. The walk-behind mower includes a handle assembly that extends upward from a frame of the walk-behind mower to support a handle. A bail arm is pivotably coupled to the handle and rotatable between an engaged position and a disengaged position without moving laterally (i.e., an axial position of the bail arm remains constant throughout operation). A bail arm sensor within the handle monitors the rotational position of the bail arm and provides a corresponding signal to a vehicle controller. A cutting switch coupled to the handle assembly can be pressed to enable cutting. The cutting switch and the rotation of the bail arm each provide a user input, such that sideways movement of the bail arm is not required to verify operator presence/intent. If an operator presses the bail arm without first pressing the cutting switch, the vehicle controller will control a driveline to propel the walk-behind mower without operating a cutting unit. When the cutting switch is pressed, the vehicle controller provides the operator with a predetermined period (e.g., three seconds) within which cutting is enabled by pulling the bail arm. If the operator releases the bail arm, the vehicle controller begins slowing the driveline and the cutting unit. If the operator re-engages the bail arm within a delay period, the vehicle controller activate the driveline and the cutting unit without another press of the cutting switch. The delay period may vary based on a cutting speed of the cutting unit.

### Overall Vehicle

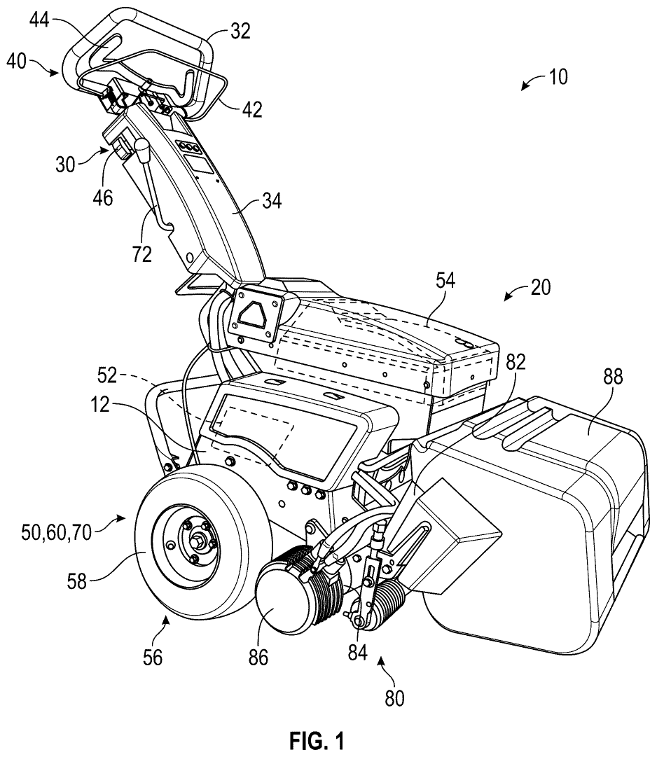

As shown in FIGS. 1-3, a machine or vehicle, shown as vehicle 10, includes a chassis, shown as frame 12; a body assembly, shown as body 20, coupled to the frame 12 and having an operator portion, operator interface, steering section, or control section, shown as handle assembly 30; operator input and output devices, shown as operator controls 40, that are positioned on the handle assembly 30 and accessible from an operator positioned behind the vehicle 10; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more implements, mower assemblies, mower decks, head units, cutting heads, or cutting units, shown as head unit 80; one or more sensors, shown as sensors 90; and a vehicle control system, shown as vehicle controller 100, coupled to the operator controls 40, the driveline 50, the suspension system 60, the braking system 70, the head unit 80, and the sensors 90. In other embodiments, the vehicle 10 includes more or fewer components.

According to an exemplary embodiment, the vehicle 10 is an off-road machine or vehicle. As shown in FIG. 1, the vehicle 10 is configured as a walk-behind mower (e.g., a lawnmower, a turf mower, a push mower, a ride-on mower, a stand-on mower, or another type of mower). A walk-behind mower may be operated by a user standing on the ground behind the mower. The walk-behind mower may be self-propelled and may be manually steered by the operator (e.g., by manually rotating the mower). In other embodiments, the off-road machine or vehicle is a lightweight or recreational machine or vehicle such as a golf cart, golf cars, an all-terrain vehicle (“ATV”), a utility task vehicle (“UTV”), and/or another type of lightweight or recreational machine or vehicle. In some embodiments, the off-road machine or vehicle is a chore product such as aerator, turf sprayer, bunker rake, and/or another type of chore product (e.g., that may be used on a golf course).

According to the exemplary embodiments shown in FIG. 1, the handle assembly 30 includes an operator interface, shown as handle 32, that is connected to the frame 12 by a post or frame member, shown as handle column 34. The handle column 34 extends upward and rearward from the frame 12 to position the handle 32 behind the body 20 near chest height of the operator. An operator may engage (e.g., grip) the handle 32 with their hands to steer, turn, or otherwise control the movement of the vehicle 10. By way of example, an operator may steer the vehicle 10 by pushing or pulling the handle 32 to manually rotate the vehicle 10.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower a head unit 80, etc.). The operator controls 40 may be used to control the speed and direction of travel of the vehicle 10. The operator controls 40 may be used to control operation of the head unit 80 (e.g., turning the head unit 80 on or off, changing a cutting speed of a head unit 80, changing a cutting height of a head unit 80, etc.).

As shown in FIG. 1, the operator controls 40 includes a first interface element, input device, operator interface, or lever, shown as bail arm 42. The bail arm 42 is pivotably coupled to the handle 32 and rotatable between a disengaged position (shown in FIG. 1) and an engaged position closer to the handle 32. An operator may pull the bail arm 42 from the disengaged position toward the engaged position to activate the driveline 50 to propel the vehicle 10 and/or to activate the head unit 80 to begin cutting.

The operator controls 40 further include a second interface element, input device, operator interface, or lever, shown as throttle paddle 44. The throttle paddle 44 is pivotably coupled to the handle 32. The throttle paddle 44 may be used to vary a driving speed (e.g., a travel speed, a traction speed, etc.) of the vehicle 10 (e.g., a speed at which the driveline 50 propels the vehicle 10). When a first portion (e.g., a left side) of the throttle paddle 44 is pressed forward, the throttle paddle 44 rotates in a first direction and increases the driving speed. When a second portion (e.g., a right side) of the throttle paddle 44 is pressed forward, the throttle paddle 44 rotates in a second direction and decreases the driving speed.

The operator controls 40 further include a third interface element, input device, operator interface, cutter control, operating mode selector, or switch, shown as cutting switch 46. The cutting switch 46 is coupled to the handle column 34 and positioned along a right side of the handle column 34. The cutting switch 46 may be used by an operator to select an operating mode of the vehicle 10. By way of example, the cutting switch 46 may be used to select a driving speed of the vehicle 10. By way of another example, the cutting switch 46 may be used to select whether or not the head unit 80 should be active and cutting.

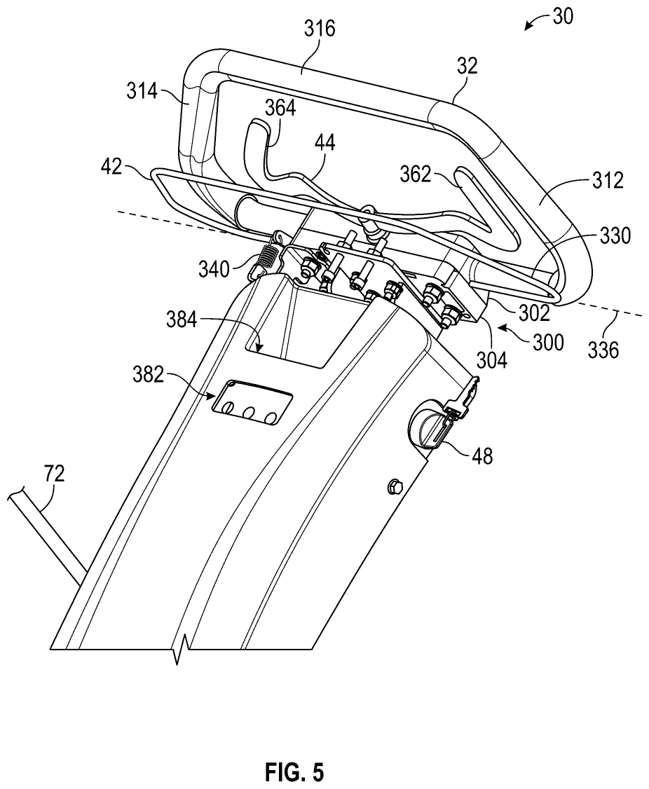

The operator controls 40 further include a fourth interface element, shown as power switch 48. As shown in FIG. 5, the power switch 48 is coupled to the handle column 34 and positioned along a left side of the handle column 34. The power switch 48 may be used by an operator to activate (e.g., power on) or deactivate (e.g., power off) the vehicle 10. In some embodiments, the power switch 48 is configured to interface with a key, such that the power switch 48 may only be used to activate the vehicle 10 when the key is present. The use of a key may prevent theft or other unauthorized operation of the vehicle 10.

The operator controls 40 further include one or more input/output devices or user interfaces, shown as operator interface 49. The operator interface 49 may include one or more output devices that communicate information to an operator and/or one or more input devices that receive information (e.g., commands) from the operator. The output device may include one or more displays such as a touchscreen, an LCD display, a LED display, a speedometer, gauges, warning lights, etc. The one or more input devices may be or include buttons, switches, knobs, levers, dials, etc.

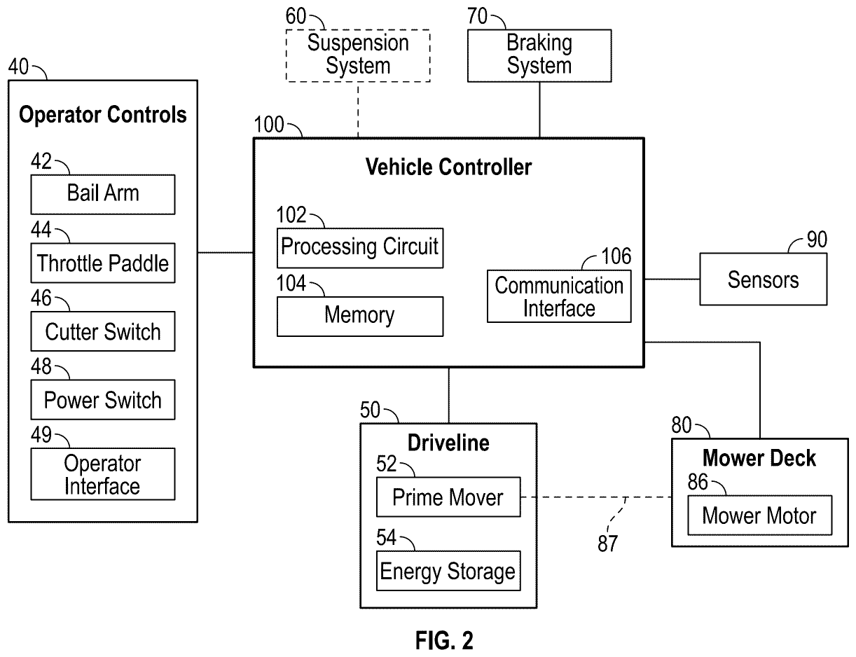

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, and a tractive assembly (e.g., axles, wheels, tracks, differentials, etc.), shown as rear tractive assembly 56. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is one or more electric motors and the energy storage 54 is a battery system. In some such embodiments, the energy storage 54 further includes an internal combustion engine that drives a generator (e.g., configured as an auxiliary power unit (APU)) to provide electrical energy to charge the battery and/or power the prime mover 52 directly. In some embodiments, the driveline 50 is a fuel cell electric driveline whereby the prime mover 52 is one or more electric motors and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements that are configured as wheels 58 (e.g., one wheel 58 on each side of the frame 12). In other embodiments, the rear tractive elements are configured as tracks. In some embodiments, the driveline 50 is omitted, and the vehicle 10 is propelled by an operator (e.g., the vehicle 10 is configured as a push mower).

According to an exemplary embodiment, the prime mover 52 is configured to provide power to drive the rear tractive assembly 56 (e.g., to provide rear-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56. The rear tractive assembly 56 may include a drive shaft, a differential, and/or an axle. In some embodiments, the rear tractive assembly 56 includes two axles or a tandem axle arrangement.

In some embodiments, the driveline 50 includes a plurality of prime movers 52. By way of example, the driveline 50 may include a first prime mover 52 that drives a first one of the wheels 58 and a second prime mover 52 that drives a second one of the wheels 58. By way of another example, the driveline 50 may include a third wheel 58 (e.g., positioned forward of the rear tractive assembly 56) that is driven by an additional prime mover 52.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include one or more rear braking components positioned to facilitate braking one or more components of the rear tractive assembly 56 (e.g., the rear axle, the wheels 58, etc.). As shown in FIG. 1, the braking system 70 includes a user interface or lever, shown as parking brake lever 72. When rotated by an operator, the parking brake lever 72 engages a parking brake that limits rotation of the wheels 58 (e.g., to hold the vehicle 10 in position when not in operation). In some embodiments, the braking system 70 is omitted and the vehicle 10. By way of example, the vehicle 10 may utilize the prime mover 52 to perform regenerative braking (e.g., within an electric motor) or engine braking (e.g., within an internal combustion engine).

Referring still to FIG. 1, the vehicle 10 includes a head unit 80 coupled to the frame 12 and positioned forward of the rear tractive assembly 56. The head unit 80 includes a deck, housing, or enclosure, shown as housing 82, and a cutting element 84 (e.g., a blade, a flail, a reel, etc.) movably coupled to the housing 82. As shown in FIG. 1, the cutting element 84 is configured as a reel that rotates about a substantially horizontal axis. In other embodiments, the cutting element 84 is configured as a blade that rotates about a substantially vertical axis.

Referring to FIG. 1, the housing 82 may open downward to expose the cutting element 84 to vegetation below the housing 82. A motor or actuator (e.g., an electric motor, a hydraulic motor, etc.), shown as mower motor 86, is coupled to the housing 82 and drives movement (e.g., rotation, oscillation, etc.) of the cutting element 84. While driven by the mower motor 86, the cutting element 84 crushes, mulches, removes, or otherwise trims vegetation beneath the housing 82. Alternatively, the cutting element 84 may be driven by the prime mover 52 (e.g., through a power take-off). By way of example, the prime mover 52 may be an engine that drives both the wheels 58 and the cutting element 84. An example of a power take-off 87 connecting the prime mover 52 to the head unit 80 is shown in FIG. 2. The power take-off 87 may transfer rotational mechanical energy between the prime mover 42 and the cutting element 84.

As shown in FIG. 1, the vehicle 10 further includes a container (e.g., a basket, a tub, a box, etc.), shown as grass catcher 88. The grass catcher 88 is removably coupled to the housing 82 at a front end of the vehicle 10. The grass catcher 88 defines a storage volume that is positioned to receive grass clippings or other vegetation cut by the cutting element 84. After the grass catcher 88 is filled, the grass catcher 88 may be removed from the vehicle 10 and taken to a dumping area (e.g., a compost bin, a trash bag) where the grass clippings are stored. Accordingly, the grass catcher 88 facilitates gathering the grass clippings produced during a mowing process.

In some embodiments, a cutting height of the head unit 80 is user-adjustable. The cutting height represents a final height of vegetation that is trimmed by the head unit 80. In some embodiments, the housing 82 is repositionable (e.g., able to be raised and lowered) relative to the frame 12 to adjust the cutting height of the head unit 80 (e.g., using an actuator or manually). In other embodiments, the housing 82 is fixed relative to the frame 12. In such an embodiment, a height of the frame 12 may be adjusted to control the cutting height of the head unit 80. By way of example, one or more rollers or wheels coupled to the frame 12 may engage a ground surface to support a front end of the frame 12. In such an embodiment, the one or more rollers or wheels may be repositioned relative to the frame 12 to adjust the cutting height.

The sensors 90 may include various sensors positioned about the vehicle 10 to acquire vehicle information or vehicle data regarding operation of the vehicle 10, or the location thereof. The sensors 90 may include various sensors positioned about the vehicle 10 to acquire environment data regarding the environment surrounding the vehicle 10. By way of example, the sensors 90 may include an accelerometer, a gyroscope, a compass, a position sensor (e.g., a GPS sensor, an RTK sensor, etc.), an inertial measurement unit (“IMU”), suspension sensor(s), wheel sensors, an audio sensor or microphone, a camera, an optical sensor, a proximity detection sensor, linear potentiometers, and/or other sensors to facilitate acquiring vehicle information, vehicle data, or environment data regarding operation of the vehicle 10, the location thereof, and/or the surrounding environment. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

As shown in FIG. 2, the vehicle controller 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle controller 100 includes a processing circuit 102, a memory 104, and a communication interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle controller 100 represents a collection of processing devices. In such cases, the processing circuit 102 represents the collective processors of the devices, and the memory 104 represents the collective storage devices of the devices.

In one embodiment, the vehicle controller 100 is configured to selectively engage, selectively disengage, control, or otherwise communicate with components of the vehicle 10 (e.g., via the communication interface 106, a controller area network (“CAN”) bus, etc.). According to an exemplary embodiment, the vehicle controller 100 is coupled to (e.g., communicably coupled to) components of the operator controls 40 (e.g., the bail arm 42, the throttle paddle 44, the cutting switch 46, the power switch 48, etc.), components of the driveline 50 (e.g., the prime mover 52), components of the braking system 70, the head unit 80, and the sensors 90. By way of example, the vehicle controller 100 may send and receive signals (e.g., control signals, location signals, etc.) with the components of the operator controls 40, the components of the driveline 50, the components of the braking system 70, the sensors 90, and/or remote systems or devices (via the communication interface 106 as described in greater detail herein).

The communication interface 106 facilitates communications (e.g., wired or wireless communications) between the vehicle 10 and other devices (e.g., other of the vehicles 10, the user sensors 220, the user portal 230, the remote systems 240, etc.). By way of example, the communication interface 106 may be configured to employ one or more types of wireless communications protocols including Bluetooth, Wi-Fi, radio, cellular, and/or other suitable wireless communications protocols.

### Site Monitoring and Control System

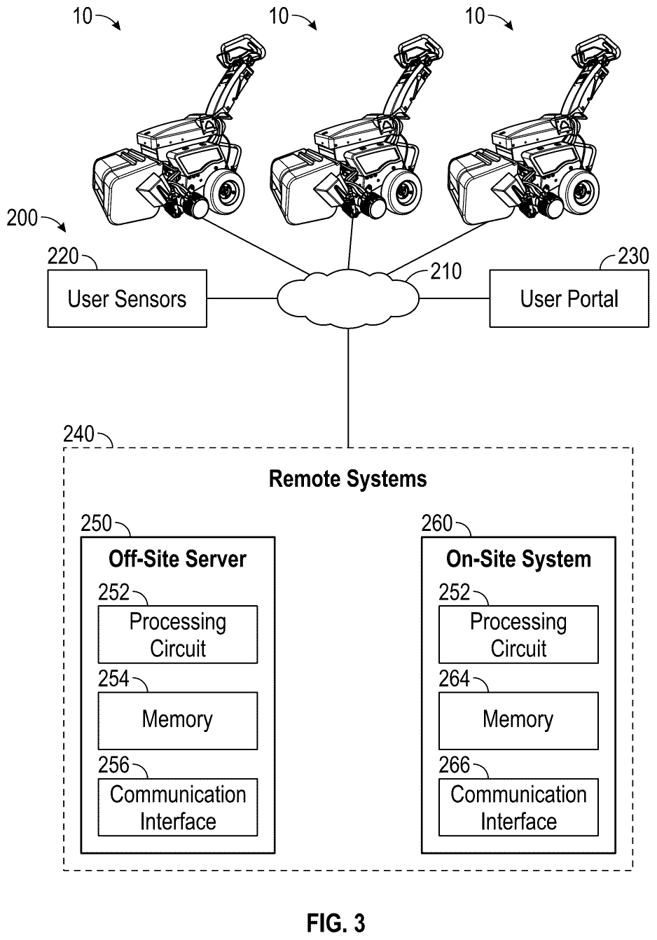

As shown in FIG. 3, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210 (e.g., using the communication interface 106).

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, hear rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc. ; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons braking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). The user portal 230 may be or may be accessed via a computer, laptop, smartphone, tablet, or the like.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle controllers 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Operator Presence Control

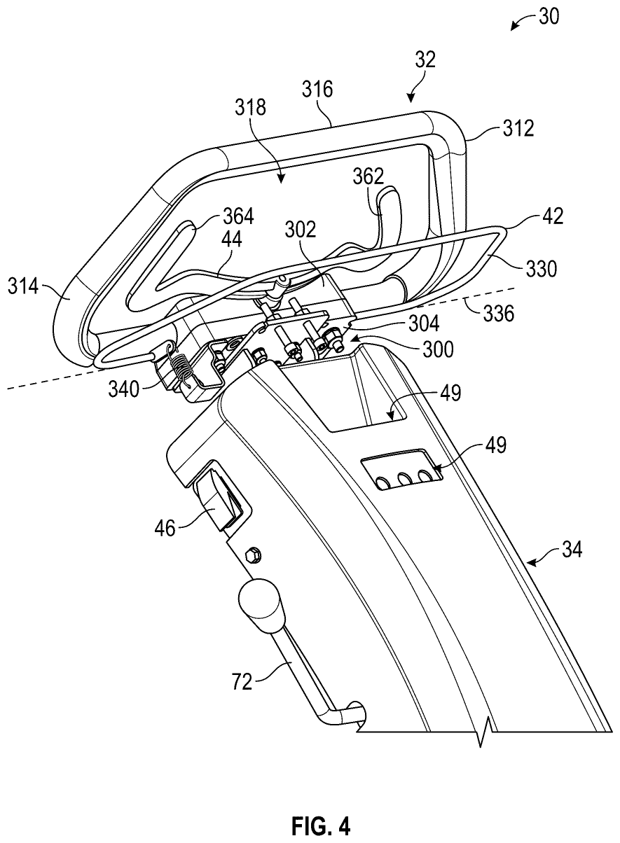

Referring to FIGS. 4-8, the handle assembly 30 includes various features that permit operator control over the operation of the vehicle 10. Using the bail arm 42, the throttle paddle 44, the cutting switch 46, and the power switch 48, the operator may control the driving speed of the driveline 50 and the cutting speed of the head unit 80. The vehicle controller 100 may process the signals from the operator controls 40 to verify the presence and intention of the operator prior to activation of certain functions (e.g., driving the cutting element 84). This may prevent unintentional operations of the vehicle 10.

As shown in FIGS. 4-7, the handle 32 is shown according to an exemplary embodiment. The handle 32 is fixedly coupled to a distal end of the handle column 34, such that the handle 32 is offset above and longitudinally rearward of the frame 12. The handle 32 includes a base, frame, or body, shown as handle body 300. The handle body 300 includes a first section, shown as handle interface 302, and a plate, shown as cover 304. The cover 304 is removably coupled to the handle interface 302 (e.g., using a plurality of fasteners). The cover 304 extends between the handle interface 302 and the handle column 34. Accordingly, the handle interface 302 may be fixedly coupled to the handle column 34 through the cover 304.

The handle body 300 defines a storage space or enclosed space, shown as internal volume 306. The internal volume 306 is defined by and extends between the handle interface 302 and the cover 304. The internal volume 306 may or store other components of the handle assembly 30.

The handle 32 further includes a user interface or grip assembly, shown as grip assembly 310. The grip assembly 310 is fixedly coupled to the handle interface 302 of the handle body 300. In some embodiments, the grip assembly 310 and the handle interface 302 are integrally formed as a single, continuous piece. The grip assembly 310 is formed from a series of grip segments or interface segments, shown as left grip 312, right grip 314, and top grip 316. The left grip 312 extends laterally outward in a first direction and upward from the handle interface 302. The right grip 314 extends laterally outward in a second direction opposite the first direction and upward from the handle interface 302. The top grip 316 extends laterally between the left grip 312 and the right grip 314. As shown, the handle interface 302 and the grip assembly 310 form a continuous loop around an opening or aperture, shown as throttle opening 318. The throttle paddle 44 may be accessible through the throttle opening 318.

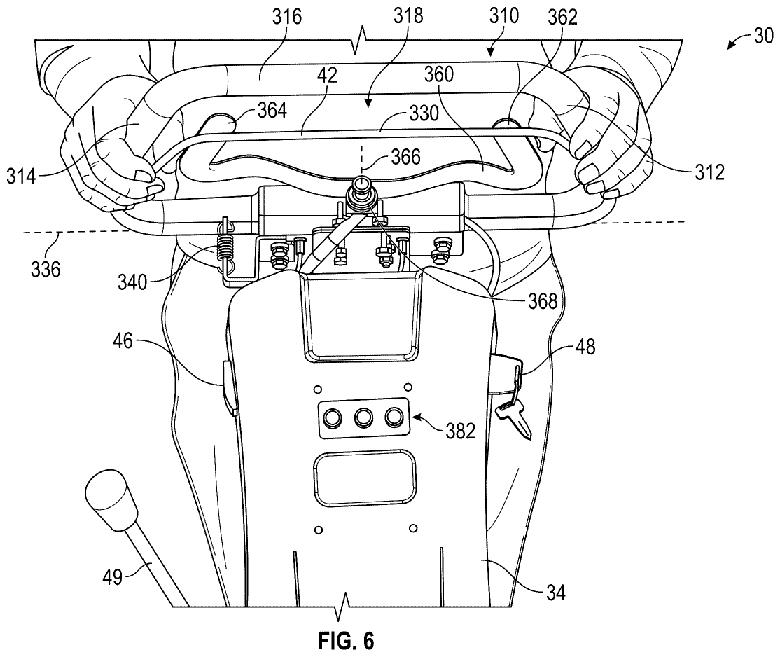

The left grip 312, the right grip 314, and the top grip 316 each provide a location for an operator to grip the handle 32, permitting the operator to stabilize themselves and apply forces to steer or turn the vehicle 10. As shown in FIG. 6, during operation of the vehicle 10, a user may engage their left hand with the left grip 312 and their right hand with the right grip 314. With the operator's hands in this position, the operator may use their thumbs to press on each end of the throttle paddle 44 by inserting their thumbs through the throttle opening 318. Alternatively, the operator may engage one or both hands with the top grip 316.

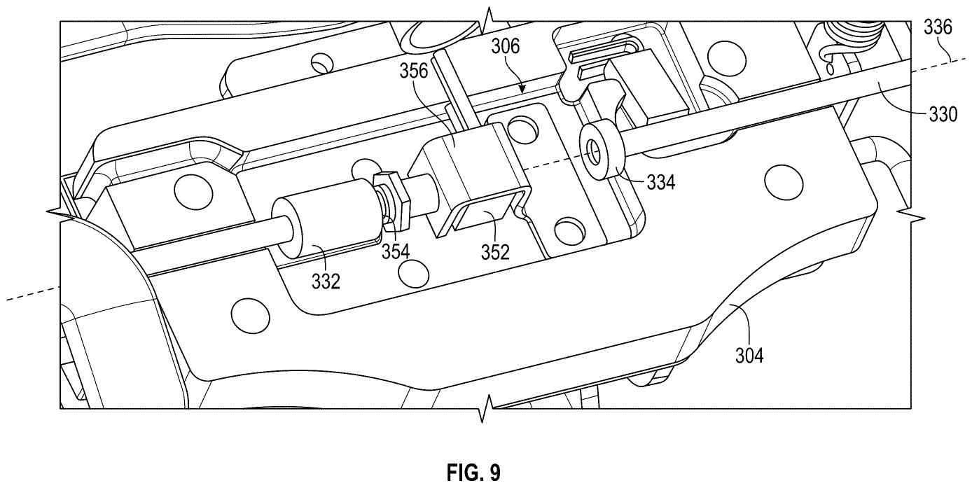

Referring to FIGS. 4-7 and 9, the bail arm 42 is shown according to an exemplary embodiment. As shown, bail arm 42 includes an interface portion or grip, shown as grip loop 330, that extends between a first end portion 332 and a second end portion 334. The grip loop 330 has a similar shape to the grip assembly 310 including a lift portion, a right portion, and a top portion extending between the left portion and the right portion. The ends of the grip loop 330 extend laterally inward, between the handle interface 302 and the cover 304. The first end portion 332 and the second end portion 334 are each received within the internal volume 306 of the handle body 300. Accordingly, the bail arm 42 is pivotably coupled to the handle body 300.

The ends of the grip loop 330, the first end portion 332, and the second end portion 334 are aligned with one another along a lateral axis, shown as axis of rotation 336. The first end portion 332 and the second end portion 334 extend radially outward from the axis of rotation 336 and radially beyond the grip loop 330. The first end portion 332 engages a first wall of the handle body 300 within the internal volume 306 to limit axial movement (e.g., lateral movement along the axis of rotation 336) in a first direction. The second end portion 334 engages a second wall of the handle body 300 within the internal volume 306 to limit axial movement (e.g., lateral movement along the axis of rotation 336) in a second direction. In some embodiments, the first end portion 332 and the second end portion 334 prevent axial movement of the bail arm 42 (i.e., such that the axial position of the bail arm 42 is constant).

The bail arm 42 is pivotable (e.g., rotatable) about the axis of rotation 336 between a disengaged position (shown in FIGS. 4 and 5) and an engaged position (shown in FIG. 6). As the bail arm 42 rotates about the axis of rotation 336, a distance between the bail arm 42 and the top grip 316 of the handle 32 varies. In the disengaged position, the bail arm 42 is positioned a first distance from the top grip 316. In the engaged position, the bail arm 42 is positioned a second distance from the top grip 316, the second distance being less than the first distance. In some embodiments, the bail arm 42 has a range of engaged positions between the disengaged position and a position adjacent to (e.g., contacting) the top grip 316. In some embodiments, the axial position of the bail arm 42 remains constant throughout the rotational range of motion of the bail arm 42 (e.g., in the disengaged position and the engaged positions).

The handle assembly 30 further includes a biasing element or tensile element, shown as bail arm spring 340. In some embodiments, the bail arm spring 340 is a tensile coil spring. The bail arm spring 340 has a first end coupled to the handle body 300 (e.g., through a bracket) and a second end coupled to the bail arm 42. The bail arm spring 340 applies a biasing force onto the handle 32. The second end of the bail arm spring 340 is offset from the axis of rotation 336 such that the biasing force of the bail arm spring 340 imparts a biasing torque on the bail arm 42. The bail arm spring 340 is positioned such that the biasing torque biases the bail arm 42 toward the disengaged position. As shown in FIG. 6, the biasing torque of the bail arm spring 340 may be overcome by the operator pulling the bail arm 42 toward the grip assembly 310 (e.g., into an engaged position). If the operator releases the bail arm 42, the bail arm spring 340 may automatically return the bail arm 42 to the disengaged position.

The bail arm 42 further includes a rotational position sensor, shown as bail arm sensor 350. The bail arm sensor 350 is positioned within the internal volume 306 of the handle body 300. The bail arm sensor 350 includes a fixed portion 352 that is fixedly coupled to the cover 304 and a rotating portion 354 that is directly and fixedly coupled to the first end portion 332 of the bail arm 42. A bracket 356 limits (e.g., prevents) rotation of the fixed portion 352 relative to the cover 304. The rotating portion 354 is inserted into the first end portion 332 and fixed relative to the first end portion 332 (e.g., by a fastener, with an adhesive, etc.).

The bail arm sensor 350 is a rotation sensor (e.g., a rotary position sensor) that measures rotation of the first end portion 332 relative to the second end portion 334. By way of example, the bail arm sensor 350 may be or include a potentiometer, a rotary encoder, a Hall effect sensor, an inductive position sensor, or another type of rotation sensor. The bail arm sensor 350 may be operatively coupled to (e.g., in communication with) the vehicle controller 100. The bail arm sensor 350 may provide a signal (e.g., sensor data, bail arm position data, bail arm angle data, etc.) indicating an angular position of the bail arm 42. Based on the provided signal, the vehicle controller 100 may determine the current angular position of the bail arm 42 (e.g., whether the bail arm 42 is in the disengaged position or the engaged position, etc.).

Referring to FIGS. 4-8, the throttle paddle 44 is shown according to an exemplary embodiment. As shown, throttle paddle 44 includes a central portion, bar, or connection portion, shown as center portion 360, that extends between a first end portion or left end portion, shown as speed up paddle 362, and a second end portion or right end portion, shown as speed down paddle 364. The center portion 360 extends laterally along the handle body 300 and the end portions of the grip loop 330 (e.g., parallel to the axis of rotation 336). The speed up paddle 362 is positioned at a first lateral end (e.g., a left end) of the center portion 360. The speed up paddle 362 extends upward from the center portion 360 and along the left grip 312. The speed down paddle 364 is positioned at a second lateral end (e.g., a right end) of the center portion 360. The speed down paddle 364 extends upward from the center portion 360 and along the right grip 314. In other embodiments, the positions of the speed up paddle 362 and the speed down paddle 364 are swapped.

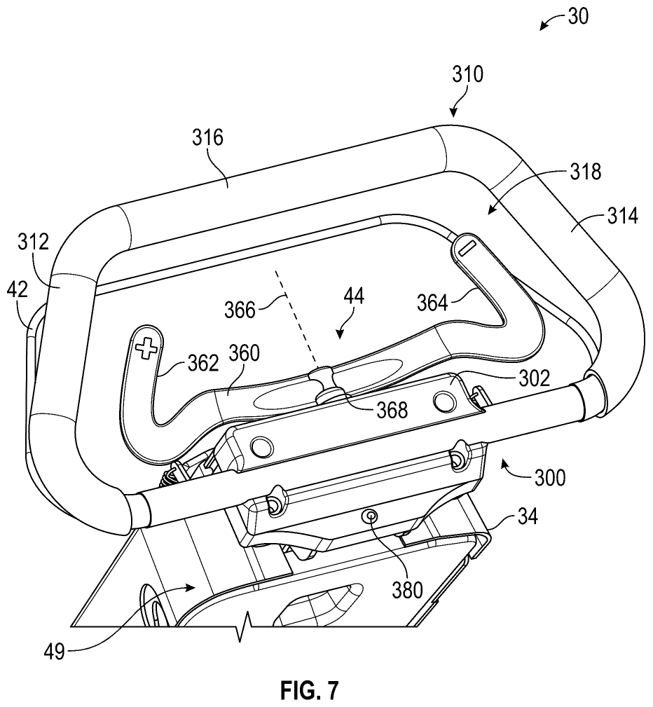

The throttle paddle 44 is pivotably coupled to the handle body 300. As shown in FIG. 7, the throttle paddle 44 is pivotable (e.g., rotatable) about an axis of rotation 366 that extends substantially perpendicular to the axis of rotation 336. The axis of rotation 336 is positioned between the speed up paddle 362 and the speed down paddle 364. Accordingly, pressing the speed up paddle 362 forward causes the throttle paddle 44 to rotate about the axis of rotation 366 in a first direction, and pressing the speed down paddle 364 forward causes the throttle paddle 44 to rotate about the axis of rotation 366 in a second direction.

The throttle paddle 44 includes a rotation sensor (e.g., a rotary position sensor), shown as throttle paddle sensor 368, that measures rotation of the center portion 360 relative to the handle body 300. By way of example, the throttle paddle sensor 368 may be or include a potentiometer, a rotary encoder, a Hall effect sensor, an inductive position sensor, or another type of rotation sensor. The throttle paddle sensor 368 may be operatively coupled to (e.g., in communication with) the vehicle controller 100. The throttle paddle sensor 368 may provide a signal (e.g., sensor data, throttle paddle position data, throttle paddle angle data, etc.) indicating an angular position of the throttle paddle 44.

Based on the provided signal, the vehicle controller 100 may determine the current angular position of the throttle paddle 44 and set a speed of the vehicle 10 based on the angular position of the throttle paddle 44 (e.g., a driving speed, a cutting speed, etc.). By way of example, the vehicle controller 100 may increase the speed when the throttle paddle 44 is moved in a direction corresponding to forward movement of the speed up paddle 362. The vehicle controller 100 may decrease the speed when the throttle paddle 44 is moved in a direction corresponding to forward movement of the speed down paddle 364. Accordingly, an operator may press on the speed up paddle 362 or the speed down paddle 364 to increase or decrease the speed, respectively.

As shown in FIG. 6, the speed up paddle 362 and the speed down paddle 364 are positioned in an ergonomically-beneficial position that facilitates adjustment of the throttle paddle 44 by an operator (e.g., to increase or decrease the speed of the vehicle 10 as desired). As shown, the speed up paddle 362 extends along the left grip 312, such that the operator's left thumb is positioned near the speed up paddle 362 when gripping the left grip 312. Accordingly, the operator may easily insert their left thumb through the throttle opening 318 to press the speed up paddle 362. The speed down paddle 364 extends along the right grip 314, such that the operator's right thumb is positioned near the speed down paddle 364 when gripping the right grip 314. Accordingly, the operator may easily insert their right thumb through the throttle opening 318 to press the speed down paddle 364. The shape of the throttle paddle 44 may facilitate adjusting the throttle paddle 44 without the operator having to reposition their hands.

Referring to FIGS. 4, 6, and 10-12, the cutting switch 46 is shown according to an exemplary embodiment. The cutting switch 46 is coupled to the right side of the handle column 34, such that the cutting switch 46 is accessible by an operator's hand. The cutting switch 46 includes a body 370 that is fixedly coupled to the handle column 34 and a movable portion or interface portion, shown as toggle 372, that is pivotably coupled to the body 370. The cutting switch 46 is a three-position switch, such that the toggle 372 is repositionable into three distinct positions.

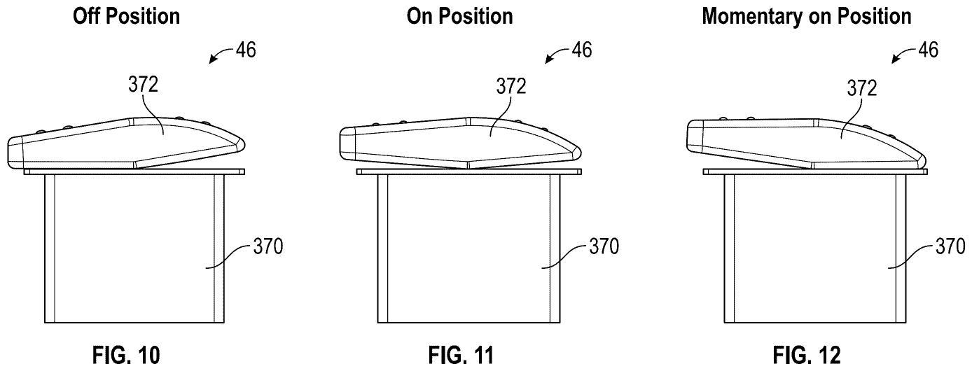

The cutting switch 46 is operatively coupled to the vehicle controller 100. The cutting switch 46 may provide a signal indicating a current position of the cutting switch 46 to the vehicle controller 100. The cutting switch 46 may be movable between the three positions by pressing onto each end of the toggle 372. The three positions of the toggle 372 are shown in FIGS. 10-12, each position corresponding to a different operating mode of the vehicle 10 set by the vehicle controller 100. The operating mode may set the driving speed of the driveline 50 and/or whether or not the mower motor 86 is activated to spin the cutting element 84.

FIG. 10 illustrates a first position or off position of the cutting switch 46. In some embodiments, the toggle 372 is capable of remaining in the off position without a continuous force being applied by the operator. With the cutting switch 46 in the off position, the vehicle controller 100 sets a target driving speed of the driveline 50 to a transport speed and deactivates (e.g., turns off) the mower motor 86. The transport speed may represent a desired driving speed for the vehicle 10 when the head unit 80 is not cutting.

FIG. 11 illustrates a second position or on position of the cutting switch 46. In some embodiments, the toggle 372 is capable of remaining in the on position without a continuous force being applied by the operator. With the cutting switch 46 in the on position, the vehicle controller 100 sets the target driving speed of the driveline 50 to a mowing speed, and the mower motor 86 may be activated or deactivated based on other operator inputs. The mowing speed may represent a desired driving speed for the vehicle 10 when the head unit 80 is operating to cut vegetation. The mowing speed may be slower than the transport speed (e.g., to facilitate consistent cutting performance when mowing).

FIG. 12 illustrates a third position or momentary on position of the cutting switch 46. The on position may be between the off position and the momentary on position. In some embodiments, the toggle 372 requires a constant force from the operator to remain in the momentary on position. The cutting switch 46 may include a spring or other biasing element that automatically returns the toggle 372 to the on position if the operator releases the toggle 372. With the cutting switch 46 in the momentary on position, the vehicle controller 100 sets the target driving speed of the driveline 50 to the mowing speed and permits activation of the mower motor 86. Turning the cutting switch 46 to the momentary on position causes the 46 to provide a cutter activation signal to the vehicle controller 100, indicating that operation of the head unit 80 should be enabled or permitted.

Referring to FIG. 5, the power switch 48 is shown according to an exemplary embodiment. The power switch 48 is coupled to the left side of the handle column 34, such that the power switch 48 is accessible by an operator's hand. The power switch 48 is a three-position switch, such that the power switch 48 is repositionable into three distinct positions. In some embodiments, the power switch 48 is repositionable by twisting a knob or key of the power switch 48.

The power switch 48 is operatively coupled to the vehicle controller 100. The power switch 48 may provide a signal indicating a current position of the cutting switch 46 to the vehicle controller 100. Each position of the power switch 48 may correspond to a different operating mode of the vehicle 10 set by the vehicle controller 100. Additionally or alternatively, the power switch 48 may function by preventing the flow of power to certain components (e.g., to the vehicle controller 100).

In a first position or off position (e.g., a 9:00 position of the knob), the power switch 48 disables the vehicle 10. When in the off position, the power switch 48 may prevent one or more systems of the vehicle 10 from operating (e.g., completely prevent operation of the vehicle 10). By way of example, the power switch 48 may disconnect the energy storage 54 from the rest of the vehicle 10. In some embodiments, the power switch 48 is capable of remaining in the off position without a constant application of force by the operator.

In a second position or on position (e.g., a 12:00 position of the knob), the power switch 48 permits operation of certain components of the vehicle 10. By way of example, the power switch 48 may permit electrical energy from the energy storage 54 to power the vehicle controller 100. In some embodiments, the power switch 48 is capable of remaining in the on position without a constant application of force by the operator.

In a third position or momentary on position (e.g., a 3:00 position of the knob), the power switch 48 enables operation of all systems of the vehicle 10. By way of example, the vehicle controller 100 may require the power switch 48 to be moved to the momentary on position prior to activating the driveline 50 or the mower motor 86. In some embodiments, the power switch 48 requires a constant application of force by the operator to remain in the momentary on position. If the operator releases the power switch 48 while in the momentary on position, the power switch 48 returns to the on position. Accordingly, an operator may switch the power switch 48 from the off position to the on position and then to the momentary on position, then release the power switch 48 to enable full operation of the vehicle 10. The operator may return the power switch 48 to the off position to disable the vehicle 10 (e.g., when the vehicle 10 is not in use).

Referring to FIG. 7, the operator interface 49 includes an output device or indicator (e.g., a light-emitting diode (LED) indicator), shown as indicator light 380. The indicator light 380 may indicate the position of the cutting switch 46. If the cutting switch 46 is in the off position, the indicator light 380 may be turned off. If the cutting switch 46 is in the on position but cutting has not yet been enabled by switching to the momentary on position, the indicator light 380 may flash. If the cutting switch 46 is in the momentary on position or the cutting switch 46 is in the on position and cutting has been enabled, the indicator light 380 may be illuminated constantly (i.e., illuminated without flashing). Accordingly, the indicator light 380 permits the operator to easily determine the operating mode of the cutting switch 46.

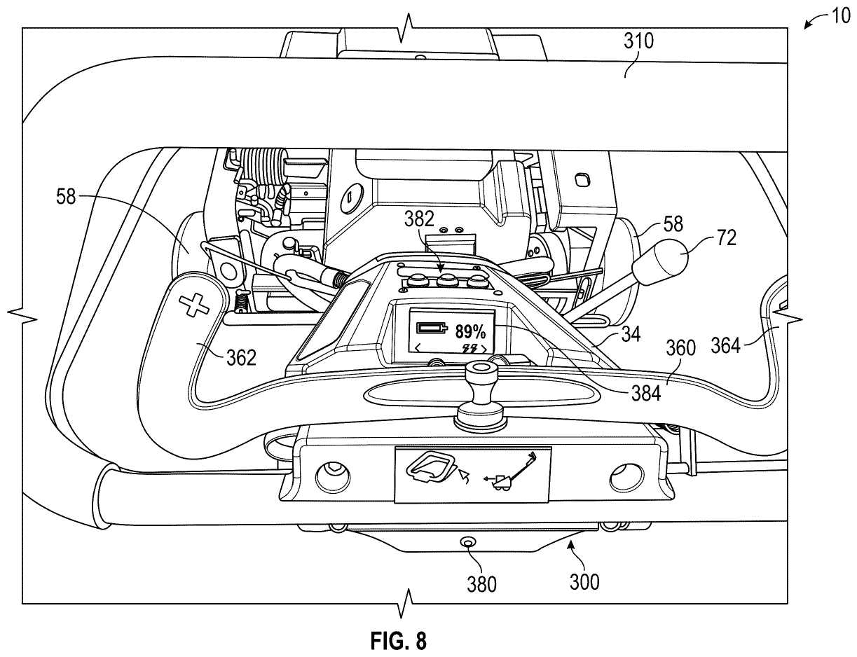

Referring to FIG. 8, the operator interface 49 includes a series of input devices, shown as display control buttons 382, and an output device, shown as display 384. The vehicle controller 100 may control the display 384 to display information to the operator. By way of example, the display may indicate a voltage or a charge level of the energy storage 54. The display control buttons 382 may permit an operator to control what information is provided on the display 384.

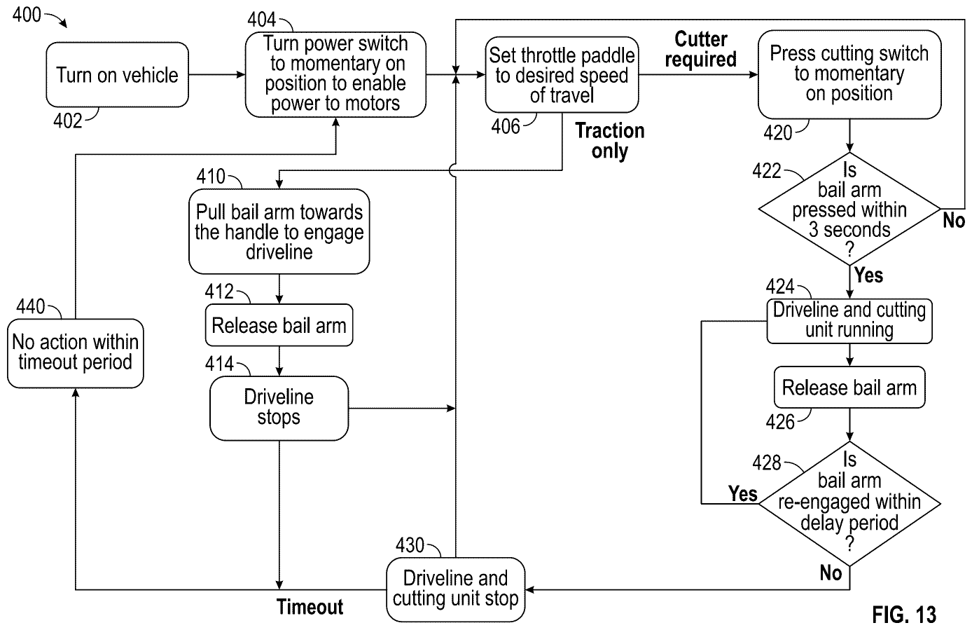

Referring to FIG. 13, a method of operating the vehicle 10 is shown as method 400 according to an exemplary embodiment. In step 402 of the method 400, the operator turns on the vehicle 10. Specifically, the operator turns the power switch 48 from the off position to the on position to enable the vehicle 10. In step 402 of the method 400, the operator turns the power switch 48 to the momentary on position to enable power to the motors of the vehicle 10. Specifically, switching the power switch 48 to the momentary on position causes the vehicle controller 100 to permit operation of the driveline 50 and the mower motor 86. The operator may release the power switch 48, and the power switch 48 may return to the on position automatically.

In step 406 of the method 400, the operator sets the throttle paddle 44 to a position corresponding to a desired speed of travel. The operator may press the speed up paddle 362 to rotate the throttle paddle 44 in a first direction and indicate that the vehicle 10 should drive faster. The operator may press the speed down paddle 364 to rotate the throttle paddle 44 in a second direction and indicate that the vehicle 10 should drive more slowly. The position of the throttle paddle 44 may be constantly monitored by the throttle paddle sensor 368, and a signal indicating the position of the throttle paddle 44 may be provided to the vehicle controller 100. The vehicle controller 100 may use the position of the throttle paddle 44 to determine the target driving speed of the vehicle 10 throughout operation of the vehicle 10. Although the step 406 is shown at this position in the method 400, the vehicle controller 100 may accept a change in the desired speed of travel from the throttle paddle 44 at any time during operation of the vehicle 10 and respond accordingly.

At this point in the method 400, an operator may determine whether they wish the vehicle 10 to drive without cutting (i.e., operate traction only) or they wish the vehicle 10 to drive while cutting (i.e., the cutter is required). The operation may switch between traction only and cutting operations at later points in the method 400 (e.g., after step 414 or step 430). The operator may proceed to step 410 or to step 420 of the method 400 based on the desired operation of the vehicle 10.

In step 410 of the method 400, the operator decides that the vehicle 10 should operate traction only (i.e., the driveline 50 should operate without the mower motor 86 operating). To achieve this, the operator pulls the bail arm 42 toward the grip assembly 310 of the handle 32 to engage the driveline 50 without moving the cutting switch 46 to the momentary on position. The bail arm sensor 350 detects that the bail arm 42 has moved from a disengaged position to an engaged position and provides a corresponding signal to the vehicle controller 100. In response, the vehicle controller 100 activates the driveline 50 to propel the vehicle 10 at the target drive speed without activating the mower motor 86.

The target drive speed may be based upon inputs from the bail arm 42, the throttle paddle 44, and the cutting switch 46. The vehicle controller 100 may increase the target drive speed as the bail arm 42 moves closer to the grip assembly 310 of the handle 32 (i.e., the closer that the operator pulls the bail arm 42 toward the grip assembly 310, the faster the vehicle controller 100 will run the driveline 50). The vehicle controller 100 may increase or decrease the target drive speed based on the position of the throttle paddle 44. The vehicle controller 100 may increase or decrease the target drive speed based on the position of the cutting switch 46. By way of example, the vehicle controller 100 may select a higher target drive speed when the cutting switch 46 is in the off position than when the cutting switch 46 is in the on position. Once the target drive speed is calculated, the vehicle controller 100 may provide a corresponding signal to the prime mover 52 to propel the vehicle 10 at the target drive speed. The vehicle controller 100 continues to operate the driveline 50, adjusting the target drive speed for any changes in the inputs, until the bail arm 42 is released by the operator.

In step 412 of the method 400, the operator releases the bail arm 42. When the operator releases the bail arm 42, the bail arm spring 340 automatically returns the bail arm 42 to the disengaged position. The bail arm sensor 350 detects that the bail arm 42 has returned to the disengaged position and provides a corresponding signal to the vehicle controller 100. In response, the vehicle controller 100 stops the driveline 50 in step 414 of the method 400. Accordingly, the vehicle 10 comes to a stop. After the vehicle controller 100 stops the driveline 50, the method 400 returns to step 406, and the operator is again permitted to select between cutting and traction only.

In step 420 of the method 400, the operator decides that cutting is required (i.e., the mower motor 86 should operate). To achieve this, the operator presses the cutting switch 46 to the momentary on position, indicating that cutting should be enabled. In response to the cutting switch 46 entering the momentary on position, the vehicle controller 100 starts a bail arm timer.

In step 422 of the method 400, the vehicle controller 100 determines whether the bail arm 42 has been pressed within a predetermined period (e.g., 3 seconds) of the cutting switch 46 entering the momentary on position. Specifically, the vehicle controller 100 monitors the signal from the bail arm sensor 350 to determine whether the bail arm 42 exits the disengaged position. If the vehicle controller 100 determines that the bail arm 42 has not entered an engaged position before the bail arm timer exceeds the predetermined period (e.g., 3 seconds), the vehicle controller 100 again disables cutting and the method 400 returns to step 406. This accommodates any accidental presses of the cutting switch 46. If the vehicle controller 100 determines that the bail arm 42 has entered an engaged position before the bail arm timer exceeds the predetermined period (e.g., in less than three seconds), cutting is enabled and the method 400 proceeds to step 424.

In step 424 of the method 400, the driveline 50 and the head unit 80 begin running. Specifically, the vehicle controller 100 provides control signals to activate the prime mover 52 and the mower motor 86. The vehicle controller 100 controls the prime mover 52 to propel the vehicle 10 at the target drive speed, which may be determined as described with respect to step 410.

Certain regulations may require two separate operator inputs before starting a cutting unit. While the bail arm 42 alone may indicate the operator is present at the vehicle 10, the use of a second input verifies the intent of the operator to begin mowing or cutting. By requiring both (a) a first interaction with the cutting switch 46 and (b) a second interaction with the bail arm 42 before starting the mower motor 86, the vehicle controller 100 may verify the operator's presence and the operator's intent to begin mowing before starting the mower motor 86.

In step 426 of the method 400, the operator releases the bail arm 42. When the operator releases the bail arm 42, the bail arm spring 340 automatically returns the bail arm 42 to the disengaged position. The bail arm sensor 350 detects that the bail arm 42 has returned to the disengaged position and provides a corresponding signal to the vehicle controller 100. In response, the vehicle controller 100 begins stopping (e.g., reduces the speed of) the driveline 50 and the mower motor 86. The vehicle controller 100 additionally starts a delay period timer when the bail arm 42 is released.

In step 428 of the method 400, the vehicle controller 100 determines whether the bail arm 42 is re-engaged within a delay period. Specifically, the vehicle controller 100 monitors the signal from the bail arm sensor 350 to determine whether the bail arm 42 exits the disengaged position. If the vehicle controller 100 determines that the bail arm 42 has re-entered an engaged position before the delay period timer exceeds the delay period, the method 400 returns to step 424 and again activates the driveline 50 and the head unit 80. If the vehicle controller 100 determines that the bail arm 42 has not entered an engaged position before the delay period timer exceeds the delay period, the method 400 moves to step 430. In step 430, the vehicle controller 100 completely stops the driveline 50 and the mower motor 86. Accordingly, the driveline 50 and the cutting element 84 come to a stop. After the vehicle controller 100 stops the vehicle 10, the method 400 returns to step 406, and the operator is again permitted to select between cutting and traction only.

Beneficially, the delay period permits the operator to re-engage the mower motor 86 without having to operate the cutting switch 46 if the operator releases the bail arm 42 for a short period of time. By way of example, the operator may release the bail arm 42 for a short period of time when turning the vehicle 10 (e.g., when turning around after mowing a straight section). By temporarily slowing the cutting element 84, the vehicle 10 can avoid damaging (e.g., creating a visible burn line on) the vegetation where the vehicle 10 is being turned. By way of another example, the operator may be able to quickly restart the mower motor 86 if the operator accidentally releases the bail arm 42 (e.g., if their fingers slip off the bail arm 42). However, if the delay period is exceeded, the vehicle controller 100 may again require an interaction with the cutting switch 46 before starting the mower motor 86. By exceeding the delay period, it may be clear that the operator no longer intends to continue mowing.

In some embodiments, the vehicle controller 100 is configured to vary the delay period. In some such embodiments, the vehicle controller 100 varies the delay period based on a current cutting speed of the head unit 80. The cutting speed may be the speed of the mower motor 86 or the cutting element 84. The cutting speed may be measured directly (e.g., the sensors 90 include a rotational sensor that measures rotation of the cutting element 84 directly) or determined based on operation of another component (e.g., by measuring the back EMF of the mower motor 86). Alternatively, the cutting speed may be determined based on the most recent command provided by the vehicle controller 100 to the mower motor 86 (e.g., run at 80% speed).

By way of example, the vehicle controller 100 may have a predetermined a maximum delay period (e.g., 3 seconds). In such an embodiment, the delay period is not permitted to be longer than the maximum delay period, but may be shorter depending upon the current cutting speed. In some embodiments, the vehicle controller 100 decreases the delay period at higher cutting speeds (e.g., the decrease is proportionate to the cutting speed). By way of example, at higher cutting speeds, damage to the vegetation caused by leaving the cutting element 84 spinning in one spot may occur more quickly. Accordingly, it may be desirable to decrease the delay period to avoid damage to the vegetation. In other embodiments, the vehicle controller 100 decreases the delay period at lower cutting speeds.

The vehicle controller 100 begins a timeout timer when the bail arm 42 is released in step 426 or step 412. If the vehicle controller 100 does not detect any action by the operator (e.g., does not receive an input) within a threshold timeout period (e.g., 300 seconds), the timeout timer reaches or exceeds the threshold timeout period, and the method 400 proceeds to step 440. In step 440, the vehicle controller 100 determines that the vehicle 10 is not being used and returns to the state of step 404. Accordingly, the vehicle controller 100 again requires the power switch 48 to be turned to the momentary on position before proceeding to step 406. By performing this timeout operation, the vehicle controller 100 requires a positive operator input prevents inadvertent operation of the vehicle 10 after the vehicle 10 has been sitting unattended.

As utilized herein with respect to numerical ranges, the terms “approximately,” “about,”“substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the vehicle controller 100, etc.) as shown in the various exemplary embodiments is illustrative only. Additionally, any element disclosed in one embodiment may be incorporated or utilized with any other embodiment disclosed herein. By way of example, a vehicle controller 100 may utilize both precision mowing and adaptive mowing.

1. A walk-behind mower, comprising:
a chassis;
a tractive element coupled to the chassis;
a cutting element rotatably coupled to the chassis;
a cutter motor coupled to the cutting element;
a handle assembly extending upward from the chassis;
a bail arm coupled to the handle assembly and repositionable between an engaged position and a disengaged position;
a power switch configured to selectively prevent operation of the walk-behind mower;
a cutter control configured to provide a cutter activation signal in response to a user interaction; and
a controller operatively coupled to the cutter motor and the cutter control and configured to:
activate the cutter motor to cause rotation of the cutting element in response to the bail arm moving toward the engaged position after receiving the cutter activation signal; and
prevent activation of the cutter motor in response to the bail arm moving toward the engaged position without having received the cutter activation signal.

2. The walk-behind mower of claim 1, wherein the controller is configured to:
initiate a timer in response to the bail arm moving into the disengaged position;
activate the cutter motor to cause the rotation of the cutting element in response to the bail arm moving toward the engaged position without having received the cutter activation signal and when the timer is below a threshold length of time; and
prevent the activation of the cutter motor in response to the bail arm moving toward the engaged position without having received the cutter activation signal when the timer is above the threshold length of time.

3. The walk-behind mower of claim 2, wherein the controller is configured to vary the threshold length of time based on a speed of the cutting element.

4. The walk-behind mower of claim 1, further comprising a drive assembly configured to drive the tractive element to propel the walk-behind mower, the drive assembly including at least one of (a) a connection between the cutter motor and the tractive element or (b) a drive motor configured to drive the tractive element.

5. The walk-behind mower of claim 4, wherein the cutter control includes a switch repositionable between a first position and a second position, and wherein the controller is configured to control the drive assembly to vary a driving speed of the walk-behind mower in response to the switch being repositioned from the first position to the second position.

6. The walk-behind mower of claim 5, wherein the switch of the cutter control is repositionable between the first position, the second position, and a third position in which the cutter control provides the cutter activation signal.

7. The walk-behind mower of claim 4, wherein the drive assembly includes the drive motor configured to drive the tractive element, wherein the cutter motor is a first electric motor, and wherein the drive motor is a second electric motor.

8. The walk-behind mower of claim 1, further comprising a throttle paddle pivotably coupled to the handle assembly, wherein the controller is configured to control the cutter motor to vary a cutting speed of the cutting element in response to rotation of the throttle paddle, and wherein the throttle paddle includes:
a central portion extending laterally between a first end portion and a second end portion;
a speed up paddle extending upward from the first end portion of the central portion; and
a speed down paddle extending upward from the second end portion of the central portion.

9. The walk-behind mower of claim 8, wherein the handle assembly includes a first grip laterally offset from a second grip, the first grip and the second grip configured to be engaged by a user to steer the walk-behind mower, wherein an opening is defined between the first grip and the second grip, and wherein the speed up paddle and the speed down paddle are accessible through the opening.

10. A walk-behind mower, comprising:
a chassis;
a tractive element coupled to the chassis;
a cutting element rotatably coupled to the chassis;
a motor coupled to the chassis and configured to drive at least one of the tractive element or the cutting element;
a handle assembly extending upward from the chassis, the handle assembly including a handle body and a grip extending outward from the handle body, and the handle body defining an internal volume;
a bail arm pivotably coupled to the handle body and extending within the internal volume of the handle body;
a bail arm sensor coupled to the bail arm and positioned within the internal volume of the handle body, wherein the bail arm sensor is configured to provide a signal indicating a rotational position of the bail arm; and
a controller operatively coupled to the motor and the bail arm sensor and configured to vary a speed of the motor based on the signal from the bail arm sensor.

11. The walk-behind mower of claim 10, wherein the bail arm is configured to rotate about an axis of rotation, and wherein the axis of rotation intersects the bail arm sensor.

12. The walk-behind mower of claim 10, further comprising a spring coupled to the bail arm and the handle body, wherein the bail arm is rotatable between an engaged position and a disengaged position, and wherein the spring is positioned to bias the bail arm toward the disengaged position.

13. The walk-behind mower of claim 12, wherein the spring is positioned outside of the internal volume of the handle body.

14. The walk-behind mower of claim 10, further comprising a throttle paddle pivotably coupled to the handle body, wherein the controller is configured to vary the speed of the motor in response to rotation of the throttle paddle, wherein the bail arm is configured to rotate about a first axis of rotation, and wherein the throttle paddle is configured to rotate about a second axis of rotation that extends substantially perpendicular to the first axis of rotation.

15. The walk-behind mower of claim 14, wherein the throttle paddle includes:
a central portion extending laterally between a first end portion and a second end portion;
a speed up paddle coupled to the first end portion of the central portion and extending away from the handle body; and
a speed down paddle coupled to the second end portion of the central portion and extending away from the handle body.

16. A walk-behind mower, comprising:
a chassis;
a tractive element coupled to the chassis;
a cutting element rotatably coupled to the chassis;
a motor coupled to the chassis and configured to drive at least one of the tractive element or the cutting element;
a handle assembly extending upward from the chassis;
a bail arm pivotably coupled to the handle assembly and rotatable about an axis of rotation between an engaged position and a disengaged position; and
a controller operatively coupled to the motor and configured to increase a speed of the motor in response to the bail arm moving from the disengaged position to the engaged position,
wherein an axial position of the bail arm along the axis of rotation remains constant as the bail arm moves between the engaged position and the disengaged position.

17. The walk-behind mower of claim 16, further comprising a cutter control configured to provide a cutter activation signal in response to a user interaction,
wherein the motor is configured to drive the cutting element, and wherein the controller is configured to:
activate the motor to drive the cutting element in response to the bail arm moving toward the engaged position after receiving the cutter activation signal; and
prevent activation of the motor in response to the bail arm moving toward the engaged position without having received the cutter activation signal.

18. The walk-behind mower of claim 17, wherein the cutter control includes a three-position switch that is configured to vary a driving speed of the walk-behind mower and provide the cutter activation signal.

19. The walk-behind mower of claim 16, further comprising a bail arm sensor configured to provide a signal to the controller indicating a rotational position of the bail arm, wherein the bail arm sensor is positioned along the axis of rotation.

20. The walk-behind mower of claim 19, wherein the handle assembly includes a handle body and a grip extending outward from the handle body, the handle body defining an internal volume, wherein the bail arm extends within the internal volume of the handle body, and wherein the bail arm sensor is positioned within the internal volume of the handle body.
